(19) United States
(12) Patent Application Publication
(10) Pub. No.: US 2026/0270144 A1
(43) Pub. Date: Sep. 10, 2026

(54) MANAGEMENT SERVER AND CONTROL METHOD THEREOF

(71) Applicant: SAMSUNG ELECTRONICS CO., LTD., Suwon-si (KR)

(72) Inventors: Jaehoon JUNG, Suwon-si (KR); Seonhee KIM, Suwon-si (KR); Jeonghun KIM, Suwon-si (KR)

(73) Assignee: SAMSUNG ELECTRONICS CO., LTD., Suwon-si (KR)

(21) Appl. No.: 19/676,164

(22) Filed: May 13, 2026

Related U.S. Application Data
(63) Continuation of application No. PCT/KR2024/014302, filed on Sep. 23, 2024.

(30) Foreign Application Priority Data
Nov. 13, 2023 (KR) 10-2023-0156312

(51) Int. Cl. H04L 41/082; H04L 67/62

(52) U.S. Cl. CPC H04L 41/082; H04L 67/62

(57) ABSTRACT

A management server includes at least one processor including: a monitoring module; and a scheduling module, including the monitoring module is configured to resource information from at least one cluster, and in which the scheduling module is configured to: receive an update request for the at least one cluster, determine an update time point of the at least one cluster based on (i) status information and network performance information included in the resource information and on (ii) a service coverage of a neighboring cluster, and transmit an update specification so as to update network functions of the at least one cluster at the determined update time point.

### CROSS-REFERENCE TO RELATED APPLICATIONS

This application is a continuation of PCT International Application No. PCT/KR2024/014302, which was filed on September 23, 2024, and claims priority to Korean Patent Application No. 10-2023-0156312, filed on November 13, 2023, the disclosures of each of which are incorporated by reference herein their entirety.

### BACKGROUND

### 1. Field

The present disclosure relates to a management server and a control method thereof. Specifically, the present disclosure provides a management server for updating a Cloud-Native Network Function (CNF) of a cluster and a control method thereof.

### 2. Description of Related Art

A management server may update a network function of at least one cluster. The network function may be a Cloud-Native Network Function (CNF). The cloud-native network function may be a unit of a service provided by a cloud architecture.

The management server may update the network function regardless of the status of the at least one cluster. When the management server updates the network function regardless of the status of the at least one cluster, network loss may occur depending on the status of the at least one cluster.

### SUMMARY

According to an aspect of the disclosure, a management server includes: at least one processor comprising: a monitoring module; and a scheduling module, in which the monitoring module is configured to resource information from at least one cluster, and in which the scheduling module is configured to: receive an update request for the at least one cluster, determine an update time point of the at least one cluster based on (i) status information and network performance information included in the resource information and on (ii) a service coverage of a neighboring cluster, and transmit an update specification so as to update network functions of the at least one cluster at the determined update time point.

According to an aspect of the disclosure, a control method of a management server includes receiving resource information from at least one cluster; receiving an update request for the at least one cluster; determining an update time point of the at least one cluster based on (i) status information and network performance information included in the resource information and on (ii) a service coverage of a neighboring cluster; and transmitting an update specification so as to update network functions of the at least one cluster at the determined update time point.

According to an aspect of the disclosure, a management server includes: memory storing one or more instructions; and at least one processor operatively coupled to the memory, in which the one or more instructions, when executed by the processor, cause the management server to: receive resource information from at least one cluster, receive an update request for the at least one cluster, determine an update time point of the at least one cluster based on (i) status information and network performance information included in the resource information and on (ii) a service coverage of a neighboring cluster, and transmit an update specification to update network functions of the at least one cluster at the determined update time point.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram illustrating a system including a management server and at least one cluster, according to one or more embodiments of the present disclosure;

FIG. 2 is a block diagram illustrating a management server according to an embodiment of the present disclosure;

FIG. 3 is a block diagram illustrating a first cluster according to an embodiment of the present disclosure;

FIG. 4 is a block diagram illustrating a cloud architecture according to an embodiment of the present disclosure;

FIG. 5 is a flowchart illustrating a control method of a management server, according to an embodiment of the present disclosure;

FIG. 6 is a flowchart illustrating a control method of a management server, for each operating subject, according to an embodiment of the present disclosure;

FIG. 7 is a diagram illustrating control of an update time point of at least one cluster according to a control method of a management server, according to an embodiment of the present disclosure;

FIG. 8 is a diagram illustrating a management server controlling an update time point of at least one cluster according to hardware resource information, according to an embodiment of the present disclosure;

FIG. 9 is a diagram illustrating a management server controlling an update time point of at least one cluster according to software resource information, according to an embodiment of the present disclosure;

FIG. 10 is a diagram illustrating a management server controlling an update time point of at least one cluster according to region information, according to an embodiment of the present disclosure;

FIG. 11 is a diagram illustrating a management server controlling an update time point of at least one cluster according to a service coverage, according to an embodiment of the present disclosure; and

FIG. 12 is a diagram illustrating a management server controlling an update time point of at least one cluster according to a Network Element (NE) type, according to an embodiment of the present disclosure; and

FIG. 13 is a block diagram of example components of one or more devices of FIG. 1.

### DESCRIPTION

Terms used in the present disclosure will be briefly described, and an embodiment of the present disclosure will be described in detail.

The terms used in the present disclosure have been selected as currently widely used general terms as possible while considering functions in an embodiment of the present disclosure, but may vary depending on the intention of those skilled in the art, precedents, the emergence of new technologies, and the like. In addition, in certain cases, there are terms arbitrarily selected by the applicant, and in this case, the meaning will be described in detail in the description of the corresponding embodiment of the present disclosure. Therefore, the terms used in the present disclosure should be defined based on the meaning of the terms and the details throughout the present disclosure, rather than simple names of the terms.

In the present disclosure, the expression “at least one of a, b, and c” may refer to “a”, “b”, “c”, “a and b”, “a and c”, “b and c”, or “all of a, b, and c”.

Throughout the present disclosure, when a part is described as “including” a certain component, this indicates that other components may be further included, rather than excluding other components, unless otherwise stated. In addition, terms such as “unit” and “module” described in the present disclosure refer to a unit that processes at least one function or operation, and may be implemented in hardware or software or a combination of hardware and software.

Hereinafter, embodiments of the disclosure will be described in detail with reference to the accompanying drawings so that those skilled in the art may easily carry out the disclosure. However, an embodiment of the present disclosure may be implemented in various different forms and is not limited to the embodiments described herein. In addition, in the drawings, parts irrelevant to the description are omitted to clearly describe an embodiment of the present disclosure, and similar reference numerals are assigned to similar parts throughout the disclosure.

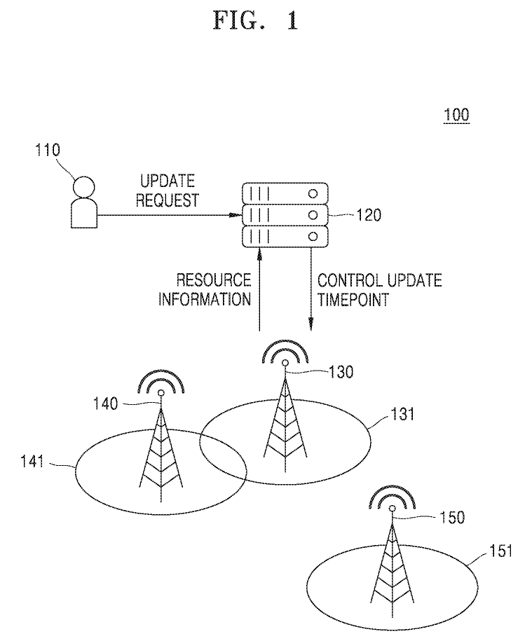

FIG. 1 is a diagram illustrating a system 100 including a management server 120 and at least one cluster 130, 140, or 150 according to an embodiment of the present disclosure.

A cluster may be a set of resources performing operation processing. The cluster may be in the form of a server, a base station, or a data center. For example, a data center may be an aggregate of a plurality of clusters including a large amount of resources.

The management server 120 may be a server that manages the at least one cluster 130, 140, or 150. The management server 120 may be referred to as a management cluster. Although one server 120 is illustrated in FIG. 1, as understood by one of ordinary skill in the art, the embodiments may include any desired number of servers. In one or more examples, the one or more servers may be distributed in a cloud architecture.

The at least one cluster 130, 140, or 150 may provide a call service to a User Equipment (UE) belonging to a designated region. The at least one cluster 130, 140, or 150 may include a plurality of clusters. For example, the at least one cluster 130, 140, or 150 may include a first cluster 130, a second cluster 140, and a third cluster 150. The at least one cluster 130, 140, or 150 may have a designated service coverage. For example, the first cluster 130 may have a first service coverage 131. For example, the second cluster 140 may have a second service coverage 141. For example, the third cluster 150 may have a third service coverage 151. The service coverage may be referred to as coverage of a cluster.

When the at least one cluster 130, 140, or 150 is located within a specified distance from the management server 120, the at least one cluster 130, 140, or 150 may be referred to as an edge cluster. When the at least one cluster 130, 140, or 150 is located farther than a specified distance from the management server 120, the at least one cluster 130, 140, or 150 may be referred to as a far edge cluster.

The management server 120 may receive resource information from the at least one cluster 130, 140, or 150. The management server 120 may periodically monitor resource information from the at least one cluster 130, 140, or 150. The resource information may include status information and network performance information.

The status information may include hardware information of the at least one cluster 130, 140, or 150, software information of the at least one cluster 130, 140, or 150, and base station status information of the at least one cluster 130, 140, or 150. The hardware information may include a hardware resource capacity of the at least one cluster 130, 140, or 150 and a hardware resource usage of the at least one cluster 130, 140, or 150. The software information may include the amount of software resources used by the at least one cluster 130, 140, or 150, the number of user equipments connected to the at least one cluster 130, 140, or 150, and the number of active calls of the at least one cluster 130, 140, or 150. The base station status information of the at least one cluster 130, 140, or 150 may include region information of the at least one cluster 130, 140, or 150, service coverage information of the at least one cluster 130, 140, or 150, and Network Element (NE) type information of the at least one cluster.

The network performance information may include a Key Performance Indicator (KPI) of a network to which the at least one cluster 130, 140, or 150 is connected. In one or more examples, KPIs are metrics used to monitor, measure, and optimize network performance. Example KPIs may include, but are not limited to, throughput, latency, packet loss, jitter, and network availability.

The management server 120 may receive an update request from a user 110. The management server 120 may analyze the resource information from the at least one cluster 130, 140, or 150 in response to the update request.

The management server 120 may determine an update time point based on the status information and the network performance information included in the resource information and of the service coverage of a neighboring cluster. The management server 120 may determine an update time point based on the hardware information of the at least one cluster 130, 140, or 150, the software information of the at least one cluster 130, 140, or 150, the base station status information of the at least one cluster 130, 140, or 150, a Key Performance Indicator (KPI) of a network to which the at least one cluster 130, 140, or 150 is connected, and a service coverage of a neighboring cluster.

The management server 120 may control the update time point of the at least one cluster 130, 140, or 150. The management server 120 may transmit an update specification to the at least one cluster 130, 140, or 150 so as to update network functions of the at least one cluster 130, 140, or 150 at the determined update time point.

The management server 120 may analyze a status of the at least one cluster 130, 140, or 150 and a status of a network to which the at least one cluster 130, 140, or 150 is connected, based on the resource information. The management server 120 may determine the update time point based on an analysis result. Accordingly, the management server 120 may reduce network loss that occurs when the network function is updated.

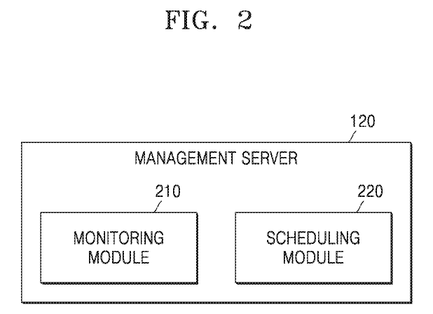

FIG. 2 is a block diagram illustrating the management server 120 according to an embodiment of the present disclosure. The management server 120 according to an embodiment may include a monitoring module 210 and a scheduling module 220. The monitoring module 210 and the scheduling module 220 may be implemented/embodied by at least one processor.

The monitoring module 210 may monitor states of a plurality of micro-services. The micro-service may include network functions of the at least one cluster 130, 140, or 150. For example, the micro-service may be a unit service that provides a Cloud-Native Network Function (CNF). In one or more examples, a CNF is a software-based networking application (e.g., such as a firewall, router, or 5G (5^{th} Generation) user plane function) that runs in lightweight containers rather than dedicated hardware or virtual machines. The micro-service may perform call processing in a cloud environment. For example, the monitoring module 210 may monitor the number of calls being processed by each of the plurality of micro-services, the number of emergency calls being processed by each of the plurality of micro-services, and a throughput of each of the plurality of micro-services. The monitoring module 210 may periodically monitor the states of the plurality of micro-services. The monitoring module 210 may transmit the monitored states of the plurality of micro-services to the scheduling module 220.

The scheduling module 220 may receive a result of monitoring the states of the plurality of micro-services from the monitoring module 210. The scheduling module 220 may determine update time points of the plurality of micro-services of the at least one cluster 130, 140, or 150. The scheduling module 220 may determine an update order and an update option of the plurality of micro-services based on an update request from the user 110. For example, the monitoring module 210 may determine an update order to update from a micro service having a small number of calls being processed among the plurality of micro services.

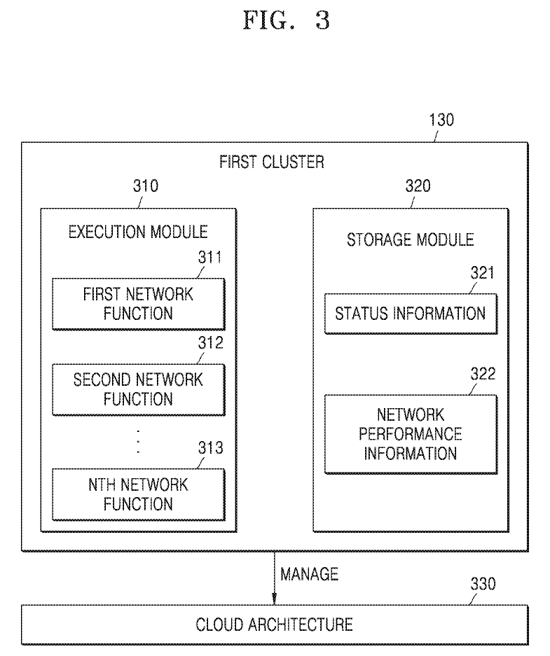

FIG. 3 is a block diagram illustrating the first cluster 130 according to an embodiment of the present disclosure. The first cluster 130 according to an embodiment may include an execution module 310 and a storage module 320. The description of the first cluster 130 with reference to FIG. 3 may be equally applied to the second cluster 140 or the third cluster 150.

The execution module 310 may execute a plurality of network functions 311, 312, and 313. The plurality of network functions 311, 312, and 313 may include functions for performing call processing. For example, the plurality of network functions 311, 312, and 313 may include a first network function 311, a second network function 312, and an Nth network function 313 (e.g., N is a natural number of 3 or more). The execution module 310 may update the plurality of network functions 311, 312, and 313. The execution module 310 may receive the update specification from the management server 120. The execution module 310 may update the plurality of network functions 311, 312, and 313 according to a requirement of the update specification.

The storage module 320 may store status information 321 and network performance information 322. The storage module 320 may transmit the status information 321 and the network performance information 322 to the management server 120.

The first cluster 130 may manage a cloud architecture 330. The plurality of network functions 311, 312, and 313 of the first cluster 130 may be cloud-native network functions that manage the cloud architecture 330.

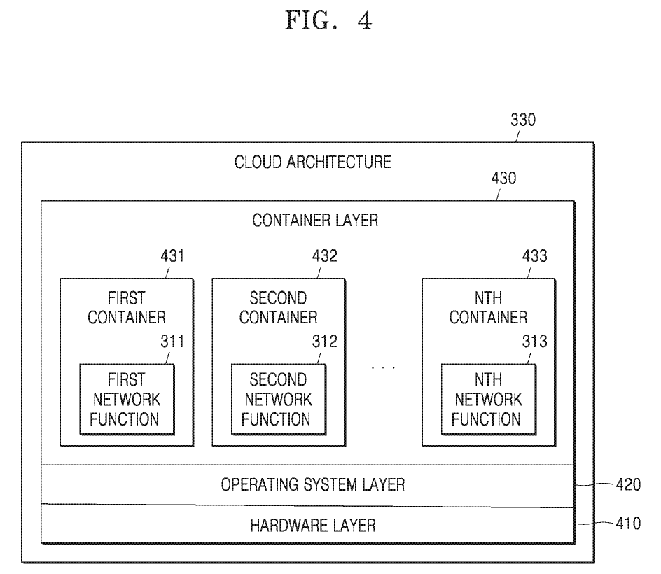

FIG. 4 is a block diagram illustrating the cloud architecture 330 according to an embodiment of the present disclosure. The cloud architecture 330 may be a structure in which a network function is virtualized using a cloud environment. The cloud architecture 330 may generate a network function by using a plurality of containers 431, 432, and 433. The cloud architecture 330 according to an embodiment may include a hardware layer 410, an Operating System (OS) layer 420, and a container layer 430.

The hardware layer 410 may include physical network equipment of the cloud architecture 330. The hardware layer 410 may include commodity hardware.

The operating system layer 420 may drive an operating system of the cloud architecture 330. The operating system layer 420 may execute a network function by driving an operating system.

The container layer 430 may include a plurality of containers 431, 432, and 433. For example, the container layer 430 may include a first container 431, a second container 432, and an Nth container 433 (N is a natural number of 3 or more).

The plurality of containers 431, 432, and 433 may include the plurality of network functions 311, 312, and 313, respectively. For example, the first container 431 may include the first network function 311. For example, the second container 432 may include the second network function 312. For example, the Nth container 433 may include the Nth network function 313. The cloud architecture 330 may include the plurality of containers 431, 432, and 433 such that each of the plurality of network functions 311, 312, and 313 provides a micro-service.

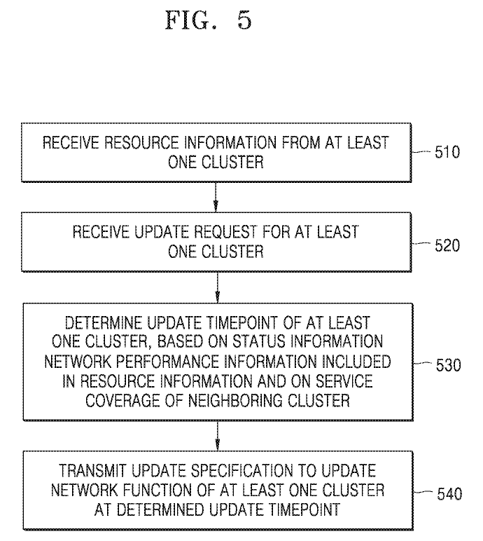

FIG. 5 is a flowchart illustrating a control method of the management server 120, according to an embodiment of the present disclosure.

In operation 510, the management server 120 according to an embodiment may receive resource information from the at least one cluster 130, 140, or 150. The at least one cluster 130, 140, or 150 may be configured with a Cloud-Native Network Function (CNF). The management server 120 may receive hardware information from the at least one cluster 130, 140, or 150. The hardware information may include CPU information, memory information, and capacity information. The management server 120 may receive software information from the at least one cluster 130, 140, or 150. The software information may include throughput information, latency information, information about the number of user equipments, and information about the number of processed calls.

In operation 520, the management server 120 according to an embodiment may receive an update request for the at least one cluster 130, 140, or 150. The management server 120 may receive an update request for the at least one cluster 130, 140, or 150 from the user 110. The management server 120 may receive an update rule related to the update request. The update rule may include at least one of an update completion deadline of the at least one cluster 130, 140, or 150, a hardware parameter of the at least one cluster 130, 140, or 150, a software parameter of the at least one cluster 130, 140, or 150, and an update region of the at least one cluster 130, 140, or 150.

In operation 530, the management server 120 according to an embodiment may determine an update time point of the at least one cluster 130, 140, or 150 based on the status information and the network performance information included in the resource information, and the service coverage of a neighboring cluster. The management server 120 may determine an update time point based on the hardware information of the at least one cluster 130, 140, or 150, the software information of the at least one cluster 130, 140, or 150, the base station status information of the at least one cluster 130, 140, or 150, a Key Performance Indicator (KPI) of a network to which the at least one cluster 130, 140, or 150 is connected, and a service coverage of a neighboring cluster.

The management server 120 may include a storage module. The storage module may store status information and a service coverage.

The management server 120 may identify a first service coverage of the at least one cluster 130, 140, or 150 and a second service coverage of a neighboring cluster. When the first service coverage and the second service coverage at least partially overlap each other, the management server 120 may set a first update period of the at least one cluster 130, 140, or 150 and a second update period of the neighboring cluster such that the update periods do not overlap each other. For example, when the first service coverage and the second service coverage at least partially overlap each other, the management server 120 may update the at least one cluster 130, 140, or 150, and update a neighboring cluster after the update of the at least one cluster 130, 140, or 150 is completed.

The management server 120 may determine an update time point based on a Network Element (NE) type of the at least one cluster 130, 140, or 150. The network element type may include whether a network function performed by the at least one cluster 130, 140, or 150 is a Central Unit (CU) or a Distributed Unit (DU). The network element type may include whether the central unit and the distributed unit operate in one cluster. The network element type may include whether the at least one cluster 130, 140, or 150 is a Stand Alone (SA) type or a Non-Stand Alone (NSA) type. The network element type may include whether the frequency band used by the at least one cluster 130, 140, or 150 is sub-6 or mmWave. When the network element type at least partially overlaps with that of the neighboring cluster, the management server 120 may set the first update period of the at least one cluster 130, 140, or 150 and the second update period of the neighboring cluster such that the update periods do not overlap.

The management server 120 may determine an update time point based on at least one of whether a neighboring cluster is updated and a version of the neighboring cluster. The management server 120 may identify a status of the neighboring cluster. The management server 120 may identify the version of the neighboring cluster based on the identified status of the neighboring cluster. The management server 120 may determine an update time point of the at least one cluster 130, 140, or 150 based on the identified version of the neighboring cluster.

The management server 120 may identify the number of User Equipments (UE) connected to the at least one cluster 130, 140, or 150, whether the number of active calls of the at least one cluster 130, 140, or 150 is less than or equal to a threshold value, and the number of currently active emergency calls. The management server 120 may identify an internal resource of a current cluster. The management server 120 may identify the number of user equipments and the number of active calls based on a result of identifying the internal resource. The management server 120 may determine an update time point based on a result of identifying the number of user equipments and the number of active calls.

When a rule other than the base station status is satisfied, the management server 120 may determine an update progress time point based on the service coverage with respect to the neighboring cluster and the network element type. When an update is not in progress in a neighboring cluster of the same network element type among neighboring clusters having a service coverage overlapping the coverage of the cluster, the management server 120 may update of the corresponding cluster.

In operation 540, the management server 120 according to an embodiment may transmit an update specification to update the network function of the at least one cluster 130, 140, or 150 at the determined update time point.

The at least one cluster 130, 140, or 150 may receive the update specification. The at least one cluster 130, 140, or 150 may update the network function based on the received update specification. The at least one cluster 130, 140, or 150 may transmit an update status in response to the update specification. The management server 120 may receive the update status transmitted from the at least one cluster 130, 140, or 150. The management server 120 may provide an update result based on the update status.

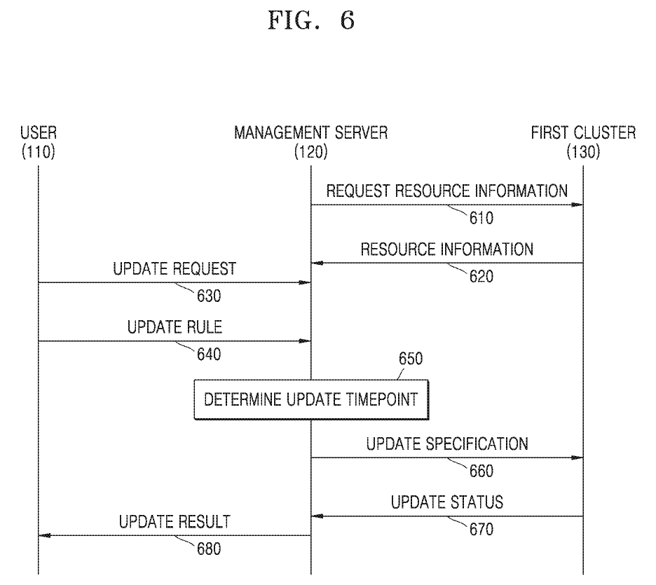

FIG. 6 is a flowchart illustrating a control method of the management server 120, for each operating subject, according to an embodiment of the present disclosure.

In operation 610, the management server 120, according to an embodiment, may request resource information from the first cluster 130.

In operation 620, the first cluster 130 according to an embodiment may provide resource information to the management server 120.

In operation 630, the management server 120 according to an embodiment may receive an update request from the user 110.

In operation 640, the management server 120 according to an embodiment may receive an update rule from the user 110. For example, the management server 120 may receive an update rule including an update completion deadline, a maximum CPU usage at the time of update, a maximum memory usage at the time of update, a maximum call drop rate at the time of update, an update region, and a network element type.

In operation 650, the management server 120 according to an embodiment may determine an update time point. The management server 120 may determine the update time point by using resource resources of the first cluster 130, which the management server 120 is monitoring, and a key performance indicator of a network.

In operation 660, the management server 120 according to an embodiment may transmit an update specification to the first cluster 130. The update specification may include details related to the update progress of a cloud-native network function included in the first cluster 130.

In operation 670, the first cluster 130 according to an embodiment may transmit the update status to the management server 120. The first cluster 130 may update the cloud-native network function according to the update specification. The first cluster 130 may transmit an update status including information related to an update progress status to the management server 120.

In operation 680, the management server 120 according to an embodiment may provide an update result. The management server 120 may provide the update result of the first cluster 130 to a user.

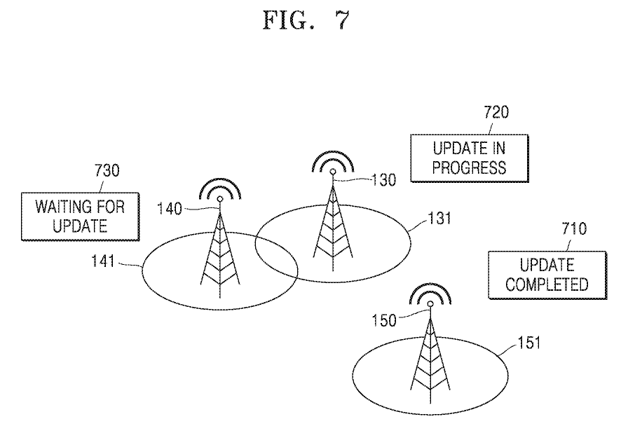

FIG. 7 is a diagram illustrating control of an update time point of the at least one cluster 130, 140, or 150 according to a control method of the management server 120, according to an embodiment of the present disclosure.

The management server 120 may update the at least one cluster 130, 140, or 150. The management server 120 may update the first cluster 130, the second cluster 140, and the Nth (N is a natural number of 3 or more) cluster 150. The management server 120 may update the first cluster 130, the second cluster 140, and the Nth cluster 150 to reduce overall network loss.

The management server 120 may control the update time point of the Nth cluster 150 such that the update of the Nth cluster 150 which has a service coverage that does not overlap that of a neighboring cluster among the at least one cluster 130, 140, or 150 is performed first. The management server 120 may receive update completion status information 710 from the Nth cluster 150.

The management server 120 may perform updating of the first cluster 130 and the second cluster 140 which have service coverages that at least partially overlap each other among the at least one cluster 130, 140, or 150 such that the updates do not overlap each other. The management server 120 may receive update-in-progress status information 720 from the first cluster 130. The management server 120 may control the update of the second cluster 140 in a standby status. The management server 120 may control the update time point of the second cluster 140 to a time point after the update of the first cluster 130 is completed. The management server 120 may receive update-standby status information 730 from the second cluster 140.

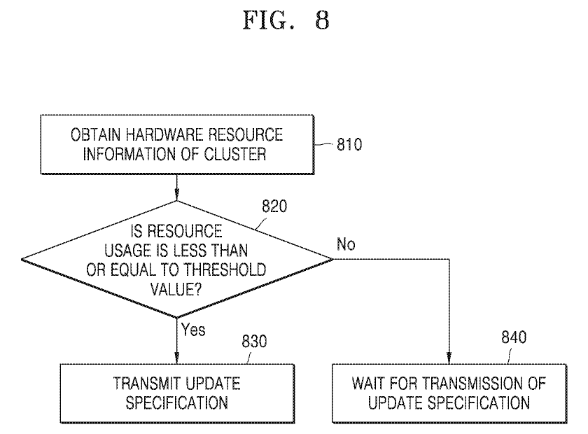

FIG. 8 is a diagram illustrating the management server 120 controlling an update time point of the at least one cluster 130, 140, or 150 according to hardware resource information, according to an embodiment of the present disclosure.

In operation 810, the management server 120 according to an embodiment may obtain hardware resource information of the cluster. The hardware resource information may include a CPU parameter of the cluster, a memory parameter of the cluster, and a capacity parameter of the cluster.

In an embodiment, the management server 120 may obtain hardware resource usage and hardware resource capacity information in a base station including the cluster, in relation to the hardware resource information of a cluster. For example, the management server 120 may obtain CPU usage of the base station including the cluster, memory usage of the base station, and capacity information of the base station. The management server 120 may qualitatively or quantitatively classify the hardware resource information. For example, the management server 120 may classify the hardware resource information into tiny (small), medium, and large. For example, the management server 120 may obtain and store the hardware resource information as a quantitative value for each parameter.

In operation 820, the management server 120 according to an embodiment may identify whether the resource usage is less than or equal to a threshold value. The threshold value of the resource usage may be a value determined for each parameter type of the hardware resource. For example, the threshold value of the CPU usage may be 5 cores. For example, the threshold value of the memory usage may be 10 gigabytes.

The management server 120 may determine whether the resource usage is less than or equal to a threshold value by additionally considering other numerical values of the hardware resource information, such as the resource usage separately from the resource usage or the resource usage. For example, when the CPU usage among the resource usage is 5 cores and the total memory capacity of the CPU is 20 gigabytes, the management server 120 may determine that the resource usage is at a threshold value.

When the resource usage is less than or equal to the threshold value (operation 820 - Yes), the management server 120 according to an embodiment may proceed to operation 830. When the resource usage is greater than the threshold value (operation 820 - No), the management server 120 according to an embodiment may proceed to operation 840.

In operation 830, the management server 120 according to an embodiment may transmit the update specification. When the resource usage is less than or equal to the threshold value, the management server 120 may determine this as a time point when the cluster may be updated. The management server 120 may transmit an update specification including a command to update the cluster when the resource usage is less than or equal to the threshold value.

In operation 840, the management server 120 according to an embodiment may wait for transmission of the update specification. When the resource usage is greater than the threshold value, the management server 120 may determine this as a time point to defer updating the cluster. When the resource usage amount is greater than the threshold value, the management server 120 may wait for transmission of the update specification until the resource usage amount becomes less than or equal to the threshold value.

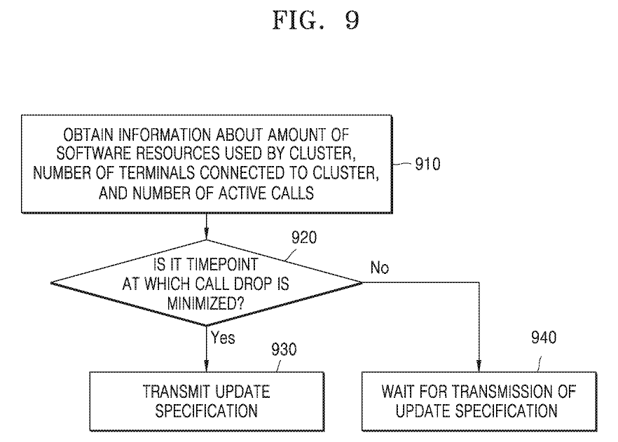

FIG. 9 is a diagram illustrating a management server controlling an update time point of at least one cluster according to software resource information, according to an embodiment of the present disclosure.

In operation 910, the management server 120 according to an embodiment may obtain information about the amount of software resources used by a cluster, the number of terminals connected to the cluster, and the number of active calls. The software resource information may include software resource usage, the number of terminals connected to a cluster, and the number of active calls. The software resource information may include a throughput parameter of the cluster, a latency parameter of the cluster, a number parameter of user equipments of the cluster, and a call number parameter. The management server 120 may obtain software resource information of the cluster. The management server 120 may obtain information on the software resource usage of the cluster, the number of terminals connected to the cluster, and the number of active calls based on the software resource information.

In an embodiment, the management server 120 may monitor the usage of software resources in a base station including the cluster, in relation to the software resource information of the cluster. For example, the management server 120 may monitor the number of user equipments connected to the base station and the number of active calls connected to the base station. The management server 120 may obtain and store the software resource information as a quantitative value.

In operation 920, the management server 120 according to an embodiment may identify whether it is a time point at which call drop is minimized. The time point at which the call drop is minimized may be determined based on the software resource information. For example, the management server 120 may predict a call drop value based on the software resource usage of the cluster, the number of terminals connected to the cluster, and the number of active calls included in the software resource information. The management server 120 may identify a time point at which a call drop is expected to be minimized. The management server 120 may identify whether a time point at which the call drop is expected to be minimized is the current time.

The management server 120 may identify a time point at which the call drop is expected to be minimized, by additionally considering other conditions separately from the software resource information or together with the software resource information. The management server 120 may receive an update rule related to at least some of the update completion deadline, the monitored hardware parameter, and the monitored base station status. The management server 120 may receive an update rule related to ae call drop condition. For example, the management server 120 may receive an update rule that a call drop rate should be less than or equal to 1 %. The management server 120 may identify a time point at which the update rule related to the call drop condition is satisfied.

When it is a time point at which the call drop is minimized (operation 920 - Yes), the management server 120 according to an embodiment may proceed to operation 930. When it is not the time point at which the call drop is minimized (operation 920 - No), the management server 120 according to an embodiment may proceed to operation 940. In one or more examples, the call drop is determined to be minimized when the number of dropped calls within a predetermined period of time is within the call drop rate specified in an update rule.

In operation 930, the management server 120 according to an embodiment may transmit an update specification. At a time point when the call drop is minimized, the management server 120 may determine that this is a time point when the cluster may be updated. The management server 120 may transmit an update specification including a command to update the cluster when the resource usage is at a time point at which the call drop is minimized. When a plurality of clusters satisfy an update condition in a multi-cluster environment, the management server 120 may preferentially update a cluster in which a lower call drop is expected among the plurality of clusters.

In operation 940, the management server 120 according to an embodiment may wait for transmission of the update specification. The management server 120 may determine this as a time point to defer updating of the cluster when it is not a time point at which the call drop is minimized. At the time point that is not a time point at which the call drop is minimized, the management server 120 may wait for transmission of the update specification until the resource usage becomes less than or equal to the threshold value.

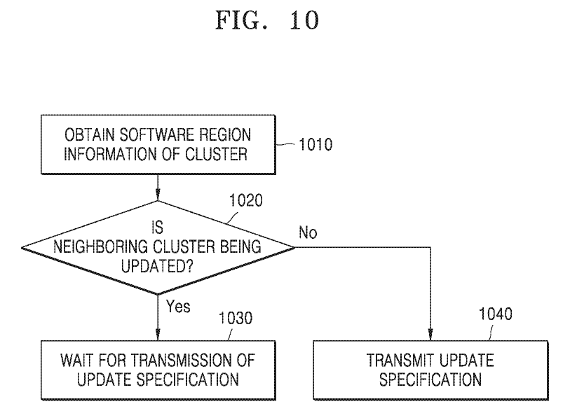

FIG. 10 is a diagram illustrating a management server controlling an update time point of at least one cluster according to region information, according to an embodiment of the present disclosure.

In operation 1010, the management server 120 according to an embodiment may obtain region information of the cluster. The region information may include information related to the actual location of the cluster. The management server 120 may obtain the region information of the cluster in order to identify the status of a neighboring cluster. The management server 120 may designate a region to be updated.

In an embodiment, in relation to the region information of the cluster, the management server 120 may monitor whether the cluster is updated and a version and a status of the cluster. For example, the management server 120 may monitor whether the neighboring cluster is updated and a version and a status of the neighboring cluster in order to identify the status of the neighboring cluster.

In operation 1020, the management server 120 according to an embodiment may identify whether the neighboring cluster is being updated. Whether the neighboring cluster is being updated may be determined based on the region information of the cluster. For example, the management server 120 may identify whether the neighboring cluster is being updated, by identifying the status of the neighboring cluster in real time.

The management server 120 may identify whether the neighboring cluster is being updated, by additionally considering other conditions separately from the region information of the cluster or together with the region information of the cluster.

When the neighboring cluster is being updated (operation 1020 -Yes), the management server 120 according to an embodiment may proceed to operation 1030. When the neighboring cluster is not being updated (operation 1020 - No), the management server 120 according to an embodiment may proceed to operation 1040.

In operation 1030, the management server 120 according to an embodiment may wait for transmission of the update specification. When the neighboring cluster is being updated, the management server 120 may determine this as a time point to defer updating the cluster. When the neighboring cluster is being updated, the management server 120 may wait for transmission of the update specification until the update of the neighboring cluster is terminated.

In operation 1040, the management server 120 according to an embodiment may transmit the update specification. When the neighboring cluster is not being updated, the management server 120 may determine this as a time point when the cluster may be updated. When the neighboring cluster is not being updated, the management server 120 may transmit an update specification including a command to update the cluster. The management server 120 may identify the status of the neighboring cluster in real time and control the update time point of the corresponding cluster.

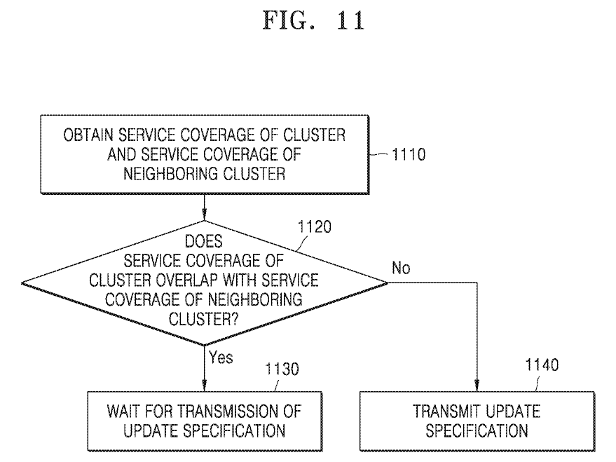

FIG. 11 is a diagram illustrating a management server controlling an update time point of at least one cluster according to a service coverage, according to an embodiment of the present disclosure.

In operation 1110, the management server 120 according to an embodiment may obtain a service coverage of a cluster and a service coverage of a neighboring cluster. A service coverage may include a management coverage of a cluster. The service coverage may be referred to as coverage of a cluster.

In an embodiment, the management server 120 may obtain frequency bandwidth information of the cluster in order to obtain a service coverage of the cluster and a service coverage of the neighboring cluster. For example, the management server 120 may identify whether the frequency bandwidth of the cluster is a millimeter wave (mmWave) band, a sub-6GHz band, or a C-band band. The service coverage of the cluster may be determined according to the frequency bandwidth of the cluster. For example, the management server 120 may identify a service coverage of the cluster for each frequency band.

In operation 1120, the management server 120 according to an embodiment may identify whether the service coverage of the cluster overlaps with the service coverage of the neighboring cluster. The management server 120 may identify whether the obtained service coverage of the cluster and the service coverage of the neighboring cluster overlap each other. For example, the management server 120 may identify whether the management coverage of the cluster and the management coverage of the neighboring cluster at least partially overlap. For example, the management server 120 may identify whether the frequency range of the cluster and the frequency range of the neighboring cluster at least partially overlap.

The management server 120 may identify whether the service coverage of the cluster and the service coverage of the neighboring cluster overlap each other, by additionally considering the service coverage of the cluster and the region information of the cluster together.

When the service coverage of the cluster overlaps with the service coverage of the neighboring cluster (operation 1120 -Yes), the management server 120 according to an embodiment may proceed to operation 1130. When the service coverage of the cluster and the service coverage of the neighboring cluster do not overlap (operation 1120 - No), the management server 120 according to an embodiment may proceed to operation 1140.

In operation 1130, the management server 120 according to an embodiment may wait for transmission of an update specification. When the service coverage of the cluster overlaps with the service coverage of the neighboring cluster, the management server 120 may determine this as a time point to defer updating the cluster. When the service coverage of the cluster overlaps with the service coverage of the neighboring cluster, the management server 120 may wait for transmission of the update specification until the update of the neighboring cluster is terminated.

When the service coverage of the cluster overlaps with the service coverage of the neighboring cluster, the management server 120 may sequentially perform the update of the cluster and the update of the neighboring cluster. When the service coverage of the cluster overlaps with the service coverage of the neighboring cluster, the management server 120 may control the update time point of the cluster such that the update of the cluster and the update of the neighboring cluster are not performed simultaneously. Accordingly, the management server 120 may control the update time point of the cluster to reduce network loss that occurs when the cluster is updated.

In operation 1140, the management server 120 according to an embodiment may transmit the update specification. When the service coverage of the cluster and the service coverage of the neighboring cluster do not overlap, the management server 120 may determine this as a time point when the cluster may be updated. When the service coverage of the cluster and the service coverage of the neighboring cluster do not overlap each other, the management server 120 may transmit an update specification including a command to update the cluster. The management server 120 may control the update time point of the corresponding cluster by identifying the service coverage of the cluster and the service coverage of the neighboring cluster in real time.

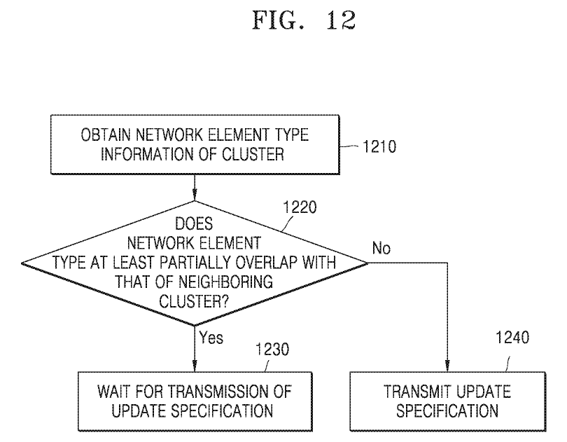

FIG. 12 is a diagram illustrating a management server controlling an update time point of at least one cluster according to a Network Element (NE) type, according to an embodiment of the present disclosure.

In operation 1210, the management server 120 according to an embodiment may obtain network element type information of the cluster. The network element type information of the cluster may include type information related to a cloud-native network function. For example, the network element type information may include a CNF type such as an Access Control Plane Function (ACPF), an Access User Plane Function (AUPF), an Access vDU Processing Function (ADPF), and a Unified Access Distribute unit Processing Function (UADPF). The management server 120 may designate a CNF type, update of which is to be performed.

In an embodiment, the management server 120 may identify and classify the type of the cluster in order to obtain the network element type information of the cluster. For example, the management server 120 may identify whether the type of the cluster is a Central Unit (CU) type or a Distributed Unit (DU) type. The management server 120 may classify a cluster of a central unit type and a cluster of a distributed unit type.

In an embodiment, the management server 120 may identify and classify a communication support coverage of the cluster in order to obtain the network element type information of the cluster. For example, the management server 120 may identify whether the communication support coverage of the cluster is SA (Stand Alone, 5G only) or NSA (Non Stand Alone, 5G+LTE). The management server 120 may classify a SA cluster and an NSA cluster.

In operation 1220, the management server 120 according to an embodiment may identify whether the network element type at least partially overlaps with that of a neighboring cluster. The management server 120 may identify the network element type of the cluster based on the obtained network element type information of the cluster. The management server 120 may identify whether the network element type of the cluster and the network element type of the neighboring cluster overlap each other. For example, the management server 120 may identify whether the type of the cluster and the type of the neighboring cluster are the same as a cluster of a central unit type or a cluster of a distributed unit type. For example, the management server 120 may identify whether the communication support coverage of the cluster and the communication support coverage of the neighboring cluster at least partially overlap.

The management server 120 may identify an association between the cluster of the central unit type and the cluster of the distributed unit type. The management server 120 may identify an association between the SA cluster and the NSA cluster. The management server 120 may perform updating based on the association between the clusters.

When the network element type at least partially overlaps with that of the neighboring cluster (operation 1220 - Yes), the management server 120 according to an embodiment may proceed to operation 1230. When the network element type does not overlap with the neighboring cluster (operation 1220 - No), the management server 120 according to an embodiment may proceed to operation 1240.

In operation 1230, the management server 120 according to an embodiment may wait for transmission of the update specification. When the network element type at least partially overlaps with that of the neighboring cluster, the management server 120 may determine this as a time point to defer updating the cluster. When the network element type at least partially overlaps with that of the neighboring cluster, the management server 120 may wait for transmission of the update specification until the update of the neighboring cluster is terminated.

When the network element type at least partially overlaps with that of the neighboring cluster, the management server 120 may sequentially perform the update of the cluster and the update of the neighboring cluster. When the network element type at least partially overlaps with that of the neighboring cluster, the management server 120 may control the update time point of the cluster such that the update of the cluster and the update of the neighboring cluster are not performed simultaneously. Accordingly, the management server 120 may control the update time point of the cluster to reduce network loss that occurs when the cluster is updated.

Before updating the SA cluster and the NSA cluster, the management server 120 may identify whether neighboring clusters which are currently being updated are the SA cluster or the NSA cluster. The management server 120 may determine the update progress time based on whether the neighboring clusters are the SA cluster or the NSA cluster. For example, when an adjacent NSA cluster is being updated, the management server 120 may wait for an update progress of another NSA cluster. Accordingly, the management server 120 may reduce LTE network loss that occurs during the update process.

In operation 1240, the management server 120 according to an embodiment may transmit an update specification. When the network element type does not overlap with that of the neighboring cluster, the management server 120 may determine this as a time point when the cluster may be updated. When the network element type does not overlap with that of the neighboring cluster, the management server 120 may transmit an update specification including a command to update the cluster. The management server 120 may identify the network element type in real time and control the update time point of the corresponding cluster.

When the update of the cluster of the central unit type is completed, the management server 120 may simultaneously update the cluster of the distributed unit type connected to the cluster of the central unit type, of which the update is completed. Accordingly, the management server 120 may reduce the time required to update a plurality of clusters.

The present disclosure provides a management server for controlling an update time point of at least one cluster based on resource information and a control method thereof.

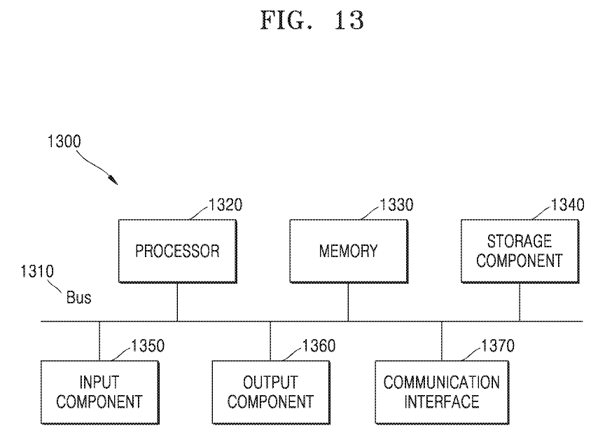

FIG. 13 is a block diagram of example components of one or more devices of FIG. 1. The device 1300 may correspond to the management server 120. As shown in FIG. 13, the device 1300 may include a bus 1310, a processor 1320, a memory 1330, a storage component 1340, an input component 1350, an output component 1360, and a communication interface 1370. In one or more examples, these components may be used to implement the monitoring module 210 and the scheduling module 220.

The bus 1310 includes a component that permits communication among the components of the device 1300. The processor 1320 is implemented in hardware, firmware, or a combination of hardware and software. The processor 1320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 1320 includes one or more processors capable of being programmed to perform a function. The memory 1330 includes a random access memory (RAM), a read only memory (ROM), and/or another type of dynamic or static storage device (e.g. a flash memory, a magnetic memory, and/or an optical memory) that stores information and/or instructions for use by the processor 1320.

The storage component 1340 stores information and/or software related to the operation and use of the device 1300. For example, the storage component 1340 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 1350 includes a component that permits the device 1300 to receive information, such as via user input (e.g. a touch screen display, a keyboard, a keypad, a mouse, a button, a switch, and/or a microphone). Additionally, or alternatively, the input component 1350 may include a sensor for sensing information (e.g. a global positioning system (GPS) component, an accelerometer, a gyroscope, and/or an actuator). The output component 1360 includes a component that provides output information from the device 1300 (e.g. a display, a speaker, and/or one or more light-emitting diodes (LEDs)).

The communication interface 1370 includes a transceiver-like component (e.g., a transceiver and/or a separate receiver and transmitter) that enables the device 1300 to communicate with other devices, such as via a wired connection, a wireless connection, or a combination of wired and wireless connections. The communication interface 1370 may permit the device 1300 to receive information from another device and/or provide information to another device. For example, the communication interface 1370 may include an Ethernet interface, an optical interface, a coaxial interface, an infrared interface, a radio frequency (RF) interface, a universal serial bus (USB) interface, a Wi-Fi interface, a cellular network interface, or the like.

The device 1300 may perform one or more processes described herein. The device 1300 may perform these processes in response to the processor 1320 executing software instructions stored by a non-transitory computer-readable medium, such as the memory 1330 and/or the storage component 1340. A computer-readable medium is defined herein as a non-transitory memory device. A memory device includes memory space within a single physical storage device or memory space spread across multiple physical storage devices.

Software instructions may be read into the memory 1330 and/or the storage component 1340 from another computer-readable medium or from another device via the communication interface 1370. When executed, software instructions stored in the memory 1330 and/or the storage component 1340 may cause the processor 1320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 13 are provided as an example. In practice, the device 1300 may include additional components, fewer components, different components, or differently arranged components than those shown in FIG. 13. Additionally, or alternatively, a set of components (e.g. one or more components) of the device 1300 may perform one or more functions described as being performed by another set of components of the device 1300.

According to an aspect of the disclosure, a management server includes: at least one processor including: a monitoring module; and a scheduling module, in which the monitoring module is configured to resource information from at least one cluster, and in which the scheduling module is configured to: receive an update request for the at least one cluster, determine an update time point of the at least one cluster based on (i) status information and network performance information included in the resource information and on (ii) a service coverage of a neighboring cluster, and transmit an update specification so as to update network functions of the at least one cluster at the determined update time point.

The at least one cluster is configured with a Cloud-Native Network Function (CNF).

The scheduling module is further configured to receive an update rule related to the update request, and the update rule includes: at least one of an update completion deadline of the at least one cluster , a hardware parameter of the at least one cluster, a software parameter of the at least one cluster, and an update region of the at least one cluster.

The management server further includes storage configured to store the status information and the service coverage.

The scheduling module is further configured to, based on determining a first service coverage of the at least one cluster and a second service coverage of the neighboring cluster at least partially overlap, a first update period of the at least one cluster and a second update period of the neighboring cluster such that the first update period and the second update period do not overlap.

The scheduling module is further configured to determine the update time point based on a Network Element (NE) type of the at least one cluster.

The scheduling module is further configured to determine the update time point based on at least one of whether the neighboring cluster is updated and a version of the neighboring cluster.

The scheduling module is further configured to: identify whether the number of User Equipment (UE) connected to the at least one cluster and a number of active calls of the at least one cluster are less than or equal to a threshold value, and determine the update time point based on a result of the identifying.

The scheduling module is further configured to receive an update status transmitted from the at least one cluster in response to the update specification.

The scheduling module is further configured to provide an update result, based on the update status.

According to an aspect of the disclosure, a control method of a management server includes receiving resource information from at least one cluster; receiving an update request for the at least one cluster; determining an update time point of the at least one cluster based on (i) status information and network performance information included in the resource information and on (ii) a service coverage of a neighboring cluster; and transmitting an update specification so as to update network functions of the at least one cluster at the determined update time point.

The control method further includes: receiving an update rule related to the update request, in which the update rule includes at least one of an update completion deadline of the at least one cluster, a hardware parameter of the at least one cluster, a software parameter of the at least one cluster, and an update region of the at least one cluster.

The control method further includes: storing the status information and the service coverage.

The control method of further includes setting, based on determining a first service coverage of the at least one cluster and a second service coverage of the neighboring cluster at least partially overlap, a first update period of the at least one cluster and a second update period of the neighboring cluster such that the first update period and the second update period do not overlap.

According to an aspect of the disclosure, a management server includes: memory storing one or more instructions; and at least one processor operatively coupled to the memory, in which the one or more instructions, when executed by the processor, cause the management server to: receive resource information from at least one cluster, receive an update request for the at least one cluster, determine an update time point of the at least one cluster based on (i) status information and network performance information included in the resource information and on (ii) a service coverage of a neighboring cluster, and transmit an update specification to update network functions of the at least one cluster at the determined update time point.

The one or more instructions, when executed by the at least one processor, further cause the management server to receive an update rule related to the update request, and the update rule includes at least one of an update completion deadline of the at least one cluster , a hardware parameter of the at least one cluster, a software parameter of the at least one cluster, and an update region of the at least one cluster.

The one or more instructions, when executed by the at least one processor, further cause the management server to: set, based on determining a first service coverage of the at least one cluster and a second service coverage of the neighboring cluster at least partially overlap, a first update period of the at least one cluster and a second update period of the neighboring cluster such that the first update period and the second update period do not overlap.

The method according to an embodiment of the present disclosure may be implemented in the form of program instructions that can be executed through various computer means and recorded in a computer-readable medium. The computer-readable medium may include program instructions, data files, data structures, and the like alone or in combination. The program instructions recorded on the medium may be specially designed and configured for the present disclosure or may be known and available to those skilled in the art of computer software. Examples of the computer-readable recording medium include magnetic media such as a hard disk, a floppy disk, and a magnetic tape, optical media such as a CD-ROM and a DVD, magneto-optical media such as a floptical disk, and hardware devices specially configured to store and execute program instructions, such as a ROM, a RAM, and a flash memory. Examples of the program instructions include not only machine language codes such as those generated by a compiler, but also high-level language codes that can be executed by a computer using an interpreter or the like.

Some embodiments of the present disclosure may also be implemented in the form of a recording medium including instructions executable by a computer, such as a program module executed by a computer. Computer-readable media may be any available media that can be accessed by a computer and includes both volatile and nonvolatile media, removable and non-removable media. Also, the computer-readable medium may include both a computer storage medium and a communication medium. The computer storage medium includes both volatile and nonvolatile media, removable and non-removable media implemented in any method or technology for storage of information such as computer-readable instructions, data structures, program modules, or other data. Communication media typically include computer readable instructions, data structures, program modules, or other data of modulated data signals such as carrier waves, or other transmission mechanisms, and include any information delivery media. In addition, some embodiments of the disclosure may be implemented as a computer program or a computer program product including instructions executable by a computer, such as a computer program executed by a computer.

A machine-readable storage medium may be provided in the form of a non-transitory storage medium. Here, ‘non-transitory storage medium’ only means that it is a tangible device and does not include signals (e.g. electromagnetic waves). This term does not distinguish between cases where data is semi-permanently stored in a storage medium and cases where data is temporarily stored. For example, the “non-transitory storage medium” may include a buffer in which data is temporarily stored.

According to an embodiment, a method according to various embodiments disclosed herein may be included and provided in a computer program product. Computer program products are commodities and may be traded between sellers and buyers. A computer program product may be distributed in the form of a machine-readable storage medium (e.g. compact disc read only memory (CD-ROM)) or distributed online (e.g., downloaded or uploaded) through an application store or directly between two user devices (e.g. smartphones). In the case of online distribution, at least a portion of the computer program product (e.g., downloadable app) may be at least temporarily stored or temporarily generated in a machine-readable storage medium, such as a memory of a manufacturer’s server, an application store’s server, or a relay server.

What is claimed is:

1. A management server comprising:
at least one processor comprising:
a monitoring module; and
a scheduling module,
wherein the monitoring module is configured to receive resource information from at least one cluster, and
wherein the scheduling module is configured to:
receive an update request for the at least one cluster,
determine an update time point of the at least one cluster based on (i) status information and network performance information included in the resource information and on (ii) a service coverage of a neighboring cluster, and
transmit an update specification so as to update network functions of the at least one cluster at the determined update time point.

2. The management server of claim 1, wherein the at least one cluster is configured with a Cloud-Native Network Function (CNF).

3. The management server of claim 1, wherein the scheduling module is further configured to receive an update rule related to the update request, and
wherein the update rule comprises:
at least one of an update completion deadline of the at least one cluster , a hardware parameter of the at least one cluster, a software parameter of the at least one cluster, and an update region of the at least one cluster.

4. The management server of claim 1,
further comprising storage module configured to store the status information and the service coverage.

5. The management server of claim 1, wherein the scheduling module is further configured to set, based on determining a first service coverage of the at least one cluster and a second service coverage of the neighboring cluster at least partially overlap, a first update period of the at least one cluster and a second update period of the neighboring cluster such that the first update period and the second update period do not overlap.

6. The management server of claim 1, wherein the scheduling module is further configured to determine the update time point based on a Network Element (NE) type of the at least one cluster.

7. The management server of claim 1, wherein the scheduling module is further configured to determine the update time point based on at least one of whether the neighboring cluster is updated and a version of the neighboring cluster.

8. The management server of claim 1, wherein the scheduling module is further configured to:
identify whether the number of User Equipment (UE) connected to the at least one cluster and a number of active calls of the at least one cluster are less than or equal to a threshold value, and
determine the update time point based on a result of the identifying.

9. The management server of claim 1, wherein the scheduling module is further configured to receive an update status transmitted from the at least one cluster in response to the update specification.

10. The management server of claim 9, wherein the scheduling module is further configured to provide an update result, based on the update status.

11. A control method of a management server, the control method comprising:
receiving resource information from at least one cluster;
receiving an update request for the at least one cluster;
determining an update time point of the at least one cluster based on (i) status information and network performance information included in the resource information and on (ii) a service coverage of a neighboring cluster; and
transmitting an update specification so as to update network functions of the at least one cluster at the determined update time point.

12. The control method of claim 11, wherein
the at least one cluster is configured with a Cloud-Native Network Function (CNF).

13. The control method of claim 11, further comprising:
receiving an update rule related to the update request,
wherein the update rule comprises:
at least one of an update completion deadline of the at least one cluster, a hardware parameter of the at least one cluster, a software parameter of the at least one cluster, and an update region of the at least one cluster.

14. The control method of claim 11, further comprising:
storing the status information and the service coverage.

15. The control method of claim 11, further comprising:
setting, based on determining a first service coverage of the at least one cluster and a second service coverage of the neighboring cluster at least partially overlap, a first update period of the at least one cluster and a second update period of the neighboring cluster such that the first update period and the second update period do not overlap.

16. A management server comprising:
memory storing one or more instructions; and
at least one processor operatively coupled to the memory,
wherein the one or more instructions, when executed by the at least one processor, cause the management server to:
receive resource information from at least one cluster,
receive an update request for the at least one cluster,
determine an update time point of the at least one cluster based on (i) status information and network performance information included in the resource information and on (ii) a service coverage of a neighboring cluster, and
transmit an update specification to update network functions of the at least one cluster at the determined update time point.

17. The management server of claim 16, wherein the at least one cluster is configured with a Cloud-Native Network Function (CNF).

18. The management server of claim 16, wherein the one or more instructions, when executed by the at least one processor, further cause the management server to receive an update rule related to the update request, and
wherein the update rule comprises at least one of an update completion deadline of the at least one cluster , a hardware parameter of the at least one cluster, a software parameter of the at least one cluster, and an update region of the at least one cluster.

19. The management server of claim 16, further comprising storage configured to store the status information and the service coverage.

20. The management server of claim 16, wherein the one or more instructions, when executed by the at least one processor, further cause the management server to:
set, based on determining a first service coverage of the at least one cluster and a second service coverage of the neighboring cluster at least partially overlap, a first update period of the at least one cluster and a second update period of the neighboring cluster such that the first update period and the second update period do not overlap.
